(19) United States
(12) Patent Application Publication
(10) Pub. No.: US 2024/0370530 A1
(43) Pub. Date: Nov. 7, 2024

(54) Elastic License Management in a SaaS Management Platform

(71) Applicant: Productiv, Inc., Palo Alto, CA (US)

(72) Inventors: Ashish Aggarwal, Los Altos Hills, CA (US); Arun Kuriakose, Palo Alto, CA (US)

(21) Appl. No.: 18/312,563

(22) Filed: May 4, 2023

Related U.S. Application Data
(63) Continuation of application No. 18/312,521, filed on May 4, 2023.

(51) Int. Cl. G06F 21/10

(52) U.S. Cl. CPC G06F 21/105; G06Q 2220/18

(57) ABSTRACT

A method implemented in a Software as a Service (SaaS) management platform (SMP) is provided, including: obtaining, over a network, usage data for a SaaS application, the usage data identifying interactivity with the SaaS application by users associated with a customer of the SMP; analyzing the usage data to determine a target provisioning status for selected ones of the users; accessing an exempt list to determine whether any of the selected ones of the users are exempt from changes to provisioning status; for the selected ones of the users that are not determined to be exempt, then performing an operation to change a current provisioning status to the target provisioning status.

This application is a continuation of, and claims priority to, U.S. application Ser. No. 18/312,521, filed May 4, 2023, entitled “Elastic License Management in a Saas Management Platform,” the disclosure of which is incorporated by reference herein.

### BACKGROUND OF THE INVENTION

Software as a service (SaaS) is a software distribution model in which applications are cloud-hosted and made available to end users over the Internet. This is advantageous for the end users in that a SaaS application is provided “as a service,” such that the end users are not required to host or maintain the application, and are enabled to access the application from practically anywhere with sufficient network connectivity. However, the rise of SaaS adoption amongst corporate entities also presents problems from a management perspective. As a given corporate entity may subscribe to many different SaaS applications, efficient SaaS management becomes increasingly difficult as a result.

It is in this context that implementations of the disclosure arise.

### SUMMARY OF THE INVENTION

Implementations of the present disclosure include methods and systems for elastic license management (ELM) in a SaaS management platform.

ELM with SSO Integration:

In some implementations, a method implemented in a Software as a Service (SaaS) management platform (SMP) is provided, the SMP implemented in a cloud resource having at least one processor and at least one storage device, the method including: obtaining, over a network, usage data for a SaaS application, the usage data identifying interactivity with the SaaS application by users associated with a customer of the SMP; analyzing the usage data to determine a target provisioning status for selected ones of the users; accessing an application programming interface (API) of a single sign-on (SSO) provider to change a current provisioning status of the selected ones of the users to the target provisioning status.

In some implementations, analyzing the usage data includes identifying the selected ones of the users as exhibiting interactivity with the SaaS application that falls below a predefined threshold.

In some implementations, the interactivity with the SaaS application that falls below a predefined threshold is defined by a lack of login or usage activity occurring within a preceding time period.

In some implementations, the change in the provisioning status is defined by deprovisioning the selected ones of the users from the SaaS application.

In some implementations, the change in the provisioning status is defined by downgrading the selected ones of the users from a current license tier to a lower license tier.

In some implementations, analyzing the usage data includes identifying the selected ones of the users as exhibiting interactivity with the SaaS application that exceeds a predefined threshold.

In some implementations, the change in the provisioning status is defined by upgrading the selected ones of the users from a current license tier to a higher license tier.

In some implementations, changing the current provisioning status to the target provisioning status includes accessing the API of the SSO provider to determine a current configuration of user groups defined by the SSO, and adding or removing the selected users from one or more of the user groups.

In some implementations, changing the current provisioning status to the target provisioning status includes accessing the API of the SSO provider to create a new user group defined by the SSO, and adding the selected users to the new user group.

In some implementations, the method further includes: responsive to analyzing the usage data, then sending a message to an administrative user of the SMP; wherein accessing the API of the SSO is responsive to receiving a response to the message.

ELM with Customer Access API:

In some implementations, a method implemented in a Software as a Service (SaaS) management platform (SMP) is provided, the SMP implemented in a cloud resource having at least one processor and at least one storage device, the method including: obtaining, over a network, usage data for a SaaS application, the usage data identifying interactivity with the SaaS application by users associated with a customer of the SMP; analyzing the usage data to determine a target provisioning status for selected ones of the users; providing an application programming interface (API) enabling access to the target provisioning status for the selected ones of the users; responsive to a request received over the network from a customer device accessing the API, then sending, over the network, data identifying the target provisioning status for the selected ones of the users.

In some implementations, analyzing the usage data includes identifying the selected ones of the users as exhibiting interactivity with the SaaS application that falls below a predefined threshold.

In some implementations, the interactivity with the SaaS application that falls below a predefined threshold is defined by a lack of login or usage activity occurring within a preceding time period.

In some implementations, the target provisioning status is defined by deprovisioning of the selected ones of the users from the SaaS application.

In some implementations, the target provisioning status is defined by downgrading of the selected ones of the users from a current license tier to a lower license tier.

In some implementations, analyzing the usage data includes identifying the selected ones of the users as exhibiting interactivity with the SaaS application that exceeds a predefined threshold.

In some implementations, the target provisioning status is defined by upgrading the selected ones of the users from a current license tier to a higher license tier.

ELM with Exempt List:

In some implementations, a method implemented in a Software as a Service (SaaS) management platform (SMP) is provided, the SMP implemented in a cloud resource having at least one processor and at least one storage device, the method including: obtaining, over a network, usage data for a SaaS application, the usage data identifying interactivity with the SaaS application by users associated with a customer of the SMP; analyzing the usage data to determine a target provisioning status for selected ones of the users; accessing an exempt list to determine whether any of the selected ones of the users are exempt from changes to provisioning status; for the selected ones of the users that are not determined to be exempt, then performing an operation to change a current provisioning status to the target provisioning status.

In some implementations, the exempt list identifies categories or types of users that are exempt from changes to provisioning status, and wherein determining whether any of the selected ones of the users are exempt from changes to provisioning status includes determining whether any of the selected ones of the users are members of the categories or types of users identified by the exempt list.

In some implementations, the exempt list identifies one or more specific users that are exempt from changes in provisioning status.

In some implementations, the exempt list identifies a minimum time period after initial provisioning during which users are exempt from changes in provisioning status.

In some implementations, the method further includes: obtaining, over the network, human resources (HR) data about the selected ones of the users; and, wherein determining whether any of the selected ones of the users are exempt includes analyzing the HR data based on the exempt list to determine whether any of the selected ones of the users are exempt from changes to provisioning status.

In some implementations, the exempt list identifies one or more roles, job titles, or departments that are exempt from changes in provisioning status.

In some implementations, the exempt list identifies a leave of absence, paid time off, sabbatical, vacation or leave status that is exempt from changes in provisioning status.

In some implementations, analyzing the usage data includes identifying the selected ones of the users as exhibiting interactivity with the SaaS application that falls below a predefined threshold.

In some implementations, the interactivity with the SaaS application that falls below a predefined threshold is defined by a lack of login or usage activity occurring within a preceding time period.

In some implementations, the target provisioning status is defined by deprovisioning of the selected ones of the users from the SaaS application.

In some implementations, the target provisioning status is defined by downgrading of the selected ones of the users from a current license tier to a lower license tier.

In some implementations, the operation of changing the current provisioning status to the target provisioning status includes accessing an application programming interface (API) of a single sign-on (SSO) provider.

Other aspects and advantages of the disclosure will become apparent from the following detailed description, taken in conjunction with the accompanying drawings, illustrating by way of example the principles of the disclosure.

### BRIEF DESCRIPTION OF DRAWINGS

The disclosure may be better understood by reference to the following description taken in conjunction with the accompanying drawings in which:

FIG. 1 conceptually illustrates a SaaS management platform and its connection to SaaS applications, in accordance with implementations of the disclosure.

FIG. 2 conceptually illustrates a system for providing elastic license management (ELM) in an SMP 100, in accordance with implementations of the disclosure.

FIGS. 3A, 3B, 3C, and 3D conceptually illustrate various example scenarios of

organizational structures utilized for app license management by an SSO, in accordance with implementations of the disclosure.

FIG. 4 conceptually illustrates a method for performing elastic license management for one or more users, in accordance with implementations of the disclosure.

FIG. 5 conceptually illustrates methods for configuring global and app-specific settings for a given customer, in accordance with implementations of the disclosure.

FIG. 6 illustrates a graph conceptually showing the benefits of elastic license management in terms of the number of licenses provisioned for a given app, in accordance with implementations of the disclosure.

### DETAILED DESCRIPTION OF THE INVENTION

The following implementations of the present disclosure provide methods and systems for elastic license management in a SaaS management platform (SMP).

The size of the average SaaS portfolio for a given company is over 250 apps, with large enterprises averaging more than 350 apps. License management for such large portfolios places a heavy demand on IT (information technology) and its operations. Companies can spend thousands of hours annually manually collecting data from each app and then removing or changing licenses assigned to employees. The number of license events can reach into the millions.

In addition to the amount of time spent, there are several challenges inherent to managing licenses manually. IT must consider the compliance risk of manually performing each licensing change. Using spreadsheets to track the changes needed is problematic, as they are prone to being out-of-date, and errors happen easily when making provisioning changes (e.g. someone accidentally skips over a row in the spreadsheet or assigns the wrong license type). Further, when a mistake is made, the IT team may not realize a mistake was made until the next update to the spreadsheet. Manual processes are inherently slow. For example, it might take IT several weeks after an employee leaves the company to deprovision all of their licenses. This makes compliance with regulations and controls, such as SOC 2 (Systems and Organization Controls 2), much more difficult.

In view of such problems arising in the management of licenses among a portfolio of apps, an elastic license management solution implemented in an SMP is provided in accordance with implementations of the disclosure. Implementations of elastic license management (ELM) enable IT teams to automate their manual processes with workflows for license deprovisioning and license tier downgrades. Furthermore, automated processes are informed by granular, up-to-date application usage data.

In some implementations, tools are provided to enable SMP customers to create workflows without coding to reduce manual steps. For example, using a no-code automation builder, one can set up automated workflows to help manage licenses for an app. Workflows can be configured to identify employees based on their license tier, activity history, and the selected organizational structure or custom user segment.

To ensure against deprovisioning or downgrading the licenses of those who need access, automated workflows can be configured to ignore newly provisioned employees and employees on an exempt list for the app. Notification processes can be implemented to notify affected staff by email or another communication channel (e.g. Slack™) before changing their license status. Employees can opt out of deprovisions or downgrades directly from the notification.

If someone has not used an application or its premium features in the timeframe set for the automation workflow, then one can automatically deprovision their account or downgrade their license. Alternatively, the workflow can be configured to provide a list of suggested employees to downgrade or deprovision.

Automated deprovisioning and downgrading is enabled, which serves to reduce compliance risk. Deprovisioning can be performed in multiple ways. In some instances, the workflow can remove assigned licenses directly in the app. If employees are accessing the app through a single sign-on (SSO) service and SCIM is configured for the app, the workflow can use the SSO to deprovision the licenses in the app. They also will be removed from the app group in the SSO, and not get re-provisioned the next time they log in to the SSO portal.

Similarly, for applications with multiple license tiers, one can automate workflows to downgrade employees who have only used features from a lower license tier. As with deprovisioning, those employees can be moved to the lower tier by taking action through the app directly or via SSO.

An automation schedule can be established to reduce IT overhead. After set up of a workflow, it can be scheduled to run on a recurring basis in addition to running it on-demand. Scheduling combined with automated provisioning enables rightsizing licenses in a customer's app environment on their cadence for proactive and continuous optimization.

In addition to freeing up IT resources and reducing compliance risks, automating license management can help in a customer's engagements with vendors. For example, some application vendors allow companies to provision more licenses than they've contracted. Yet if licenses are right-sized regularly, unplanned true-ups from the vendor are less likely. Usage data reveals how many licenses are actually being used, so finance and procurement leaders can proactively contract for additional licenses if needed. With insights into how many employees are using an application and what features are being used, customers are better prepared for renewal discussions, and can avoid over-procuring licenses.

It will be obvious, however, to one skilled in the art, that the present disclosure may be practiced without some or all of the specific details presently described. In other instances, well-known process operations have not been described in detail in order not to obscure the present implementations.

Implementations of the present disclosure are implemented using a SaaS management platform (SMP). Broadly speaking, a SaaS management platform connects to, and obtains data from, a given customer's portfolio of SaaS applications, and provides analysis and insights relating to the customer's usage of their SaaS applications. One example of a SaaS management platform is Productiv™ provided by Productiv, Inc. For a fuller understanding of the present disclosure, an example of a SaaS management platform is herein described.

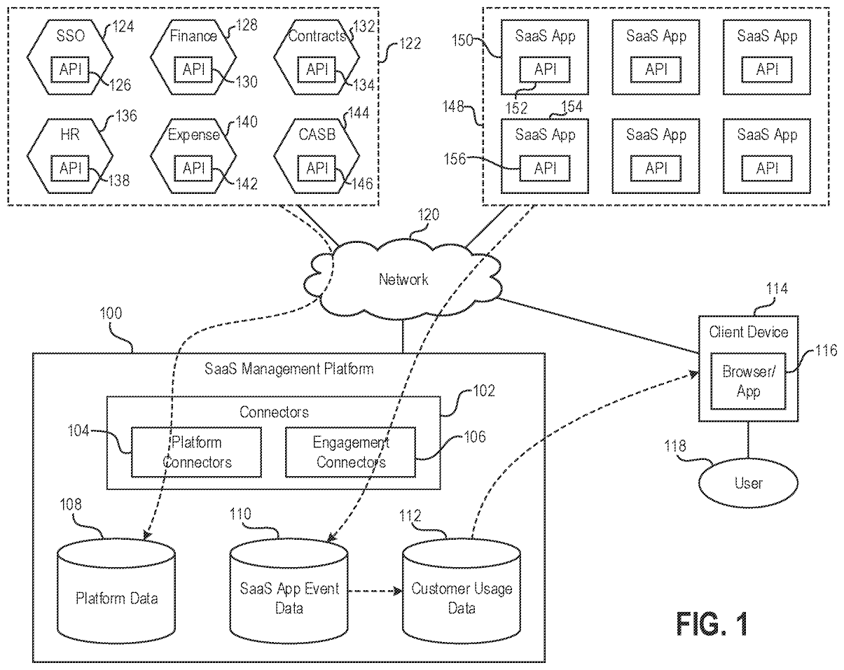

FIG. 1 conceptually illustrates a SaaS management platform and its connection to SaaS applications, in accordance with implementations of the disclosure.

In the illustrated implementation, a SaaS management platform 100 includes connectors 102 that are configured to obtain data from various applications/platforms, typically by calling their exposed Application Programming Interfaces (APIs). Connectors 102 are further distinguished between platform connectors 104 and engagement connectors 106.

Platform connectors 104 are configured to obtain data from platform applications/services 122. Broadly speaking, platform applications 122 provide contextual information to identify, enable access, and understand customer usage context of the SaaS applications which the customer is seeking to manage via the SMP 100. It will be appreciated that platform applications may themselves be SaaS applications, but are distinguished from other SaaS applications in the present disclosure as they are used to provide information about the customer that is used as a contextual basis for understanding SaaS application usage. In some implementations, a given platform application/service may be installed on-premise at the customer organization/entity. Examples of platform applications 122 include a single sign-on (SSO) service 124, a human resources (HR) management system 136, a finance application 128, an expense application 140, a contracts management application 132, and a networking service 144 (e.g. cloud access security broker (CASB)).

In some implementations, the SSO service 124 exposes an API 126, and a corresponding one of the platform connectors for the SSO service 124 is configured to obtain data from the SSO service using the API 126. A list of SSO-enabled applications can be obtained, as well as user login activity for each application, thereby providing broad visibility into the customer's SaaS application portfolio. By way of example without limitation, examples of SSO services include Okta™, Azure Active Directory™, Duo Security™, Idaptive™, OneLogin™, PingOne™, and Google Workspace™.

In some implementations, the HR management system 136 exposes an API 138, and a corresponding one of the platform connectors for the HR management system 136 is configured to obtain data from the HR management system 136 using the API 138. The customer's org chart data can be obtained from the HR management system 136, identifying the reporting structure and various organizational groups within the customer organization. Org chart data can be useful in enabling understanding of SaaS application usage and trends and distinguishing how they vary by team, location, and manager. Examples of HR management systems include Workday™, OneLogin™, Okta™, Azure Active Directory™, and Google Workspace™.

In some implementations, the finance application 128 exposes an API 130, and a corresponding one of the platform connectors for the finance application 128 is configured to obtain data from the finance application using the API 130. Payments data from the finance application 128 can be useful for discovering SaaS applications that are not otherwise known, and may not be managed by the customer's information technology (IT) department. Examples of finance application 128 include ERP systems such as Netsuite™ and Oracle™.

In some implementations, the expense application 140 exposes an API 142, and a corresponding one of the platform connectors for the expense application 140 is configured to obtain data from the expense application using the API 142. As with the payments data noted above, expense data from the expense application can also be useful for discovering SaaS applications that are not otherwise known, and may not be managed by the customer's information technology (IT) department. Examples of expense application 140 include Concur™ and Expensify™.

In some implementations, the contracts management application 132 exposes an API 134, and a corresponding one of the platform connectors for the contracts management application 132 is configured to obtain data from the contracts management application using the API 134. Contracts data can be used to provide visibility into license levels and contract spend, enabling recommendations for rightsizing and renewing licenses, as well as reclaiming unused licenses. Examples of contract management applications include Coupa™ and Ironclad™.

In some implementations, the networking service 144 exposes an API 146, and a corresponding one of the platform connectors for the networking service 144 is configured to obtain data from the networking service using the API 146. In some implementations, the networking service 144 is defined by a cloud access security broker (CASB) or other service/application that serves as a security enforcement point between the customer organization/entity and its SaaS applications or other cloud services. Data obtained from the networking service 144 provides another source for discovering applications through user logins and use over network activity.

It will be appreciated that the platform connectors 104 can be configured to automatically update data over time, for example, periodically pulling data from the relevant sources. In this manner, customer-specific contextual data for understanding SaaS application usage is continually maintained and tracks the current state of the customer organization. The data obtained from the customer's platform applications 122 is stored in the SMP 100 as platform data 108. While platform connectors 104 enable automatic retrieval of data directly from the customer's platform applications/services, it will be appreciated that, in the alternative, a given customer may upload their platform application data to the SMP 100.

The engagement connectors 106 are configured to obtain data pertaining to usage of the customer's SaaS application portfolio 148. For example, a given SaaS application 150 may expose an API 152, and a corresponding one of the engagement connectors 106 for the SaaS application 150 is configured to call the API 152 to obtain data describing events that occurred through customer usage of the SaaS application 150. Likewise, a given SaaS application 154 may expose an API 156, and a corresponding one of the engagement connectors 106 for the SaaS application 154 is configured to call the API 156 to obtain data describing events that occurred through customer usage of the SaaS application 154. It will be appreciated that there can be many SaaS applications in the customer's SaaS application portfolio 148, and each may expose an API that is called by a corresponding engagement connector to obtain data describing events occurring through usage of the applications. Such data is stored in the SMP 100 as SaaS app event data 110.

As described in further detail below, the SaaS app event data 110 is processed and analyzed to determine various aggregations and information describing the customer's usage of their SaaS application portfolio 148, which is stored as customer usage data 112. Such usage data can be accessed for viewing via a client device 114 operated by a user 118 (e.g. an employee of the customer organization viewing the usage data of the customer organization). By way of example without limitation, examples of client devices include personal computers, laptops, tablets, cellular phones, mobile devices, etc. In some implementations, the SMP 100 is accessed via a browser or application executed by the client device 114, and the customer usage data 112 is provided for viewing through the browser/application.

In the present disclosure the terms “application” and “app” are used interchangeably. Generally, an “app” refers to a SaaS application that is capable of being managed through the SMP.

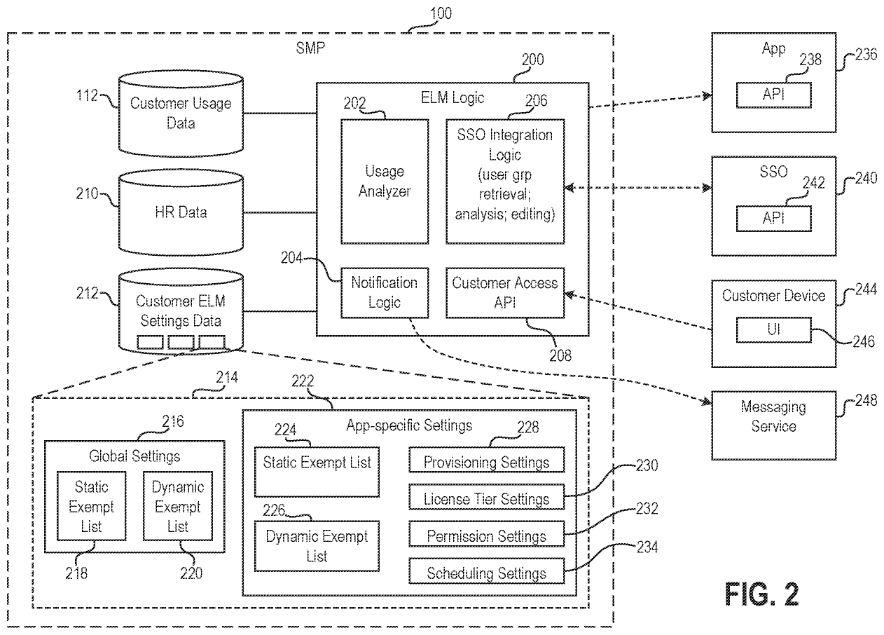

FIG. 2 conceptually illustrates a system for providing elastic license management (ELM) in an SMP 100, in accordance with implementations of the disclosure.

Broadly speaking, the illustrated system enables a customer of the SMP to implement automated deprovisioning of licenses, as well as automated downgrading or upgrading of license tiers, and automated downgrading or upgrading of permission of users. These functionalities are implemented via ELM logic 200, which is configured to analyze users' usage of apps, and take various actions in relation to their licensing if warranted. The ELM logic 200 implements license management in accordance with customer settings which are stored to a customer ELM settings data storage 212.

By way of example in the illustrated implementation, a given customer may have a set of customer ELM settings 214, which define parameters for how the license management activities will be implemented by the ELM logic 200 for that customer. For a given app 236, app-specific settings 222 are defined that include parameters for management of licenses for the app 236. In various implementations, certain ones of the app-specific settings 222 can be defined by the customer (e.g. by an administrative user), or provided with defaults or inferred by the system in some implementations.

Provisioning settings 228 define what parameters are used to determine whether a user should be deprovisioned from the app 236. For example, the parameters may define that a user should be deprovisioned from the app 236 if they have not logged-in or otherwise accessed or used the app 236 within a specified prior time period (e.g. within the past N number of days/weeks/months, within the past 60 days, within the past 10 weeks, within the past 3 months, etc.), or if they have logged-in/accessed/used the app 236 less than a predefined number of times with a specified prior time period. As another example, the parameters may define that a user should be deprovisioned from the app 236 if they have not used, or used less than a predefined amount, a certain feature of the app 236 within a specified prior time period.

The provisioning settings 228 further define what should happen when it is determined that a user should be deprovisioned from the app 236. For example, in some implementations the provisioning settings 228 define that the user will be notified via a designated communications channel or mechanism, such as through an email, chat, text message, direct message, or other electronic message. In some implementations, the provisioning settings 228 define that the user will be deprovisioned by the SMP itself. It will be appreciated that in some implementations, the provisioning settings 228 may not define a specific action to be taken as a result of determining that a user should be deprovisioned from the app 236. However, the result of such a determination is stored, and can be retrieved by the customer as further described herein.

In view of the above, the provisioning settings 228 are accessed by the ELM logic 200 to carry out license management activities on behalf of the customer. More specifically, a usage analyzer 202 is configured to analyze users' usage of the app 236 in accordance with the provisioning settings 228 to determine which users should be deprovisioned from the app 236. In some implementations, the users' app usage data is obtained from the customer usage data 112, which can include login history as well as feature level usage data. And in some implementations wherein login to the app 236 is managed via an SSO 240, the users' login history can be obtained from the SSO 240 (e.g. via an application programming interface (API) 242 of the SSO 240). Thus in accordance with the provisioning settings 228 as described above, the usage analyzer 202 can be configured to determine which users should be deprovisioned, for example, based on whether or not they have logged in or otherwise accessed/used the app 236 within a specified prior time period. For example, users that have not logged into the app 236 within the last 60 days may be considered to be users that ought to be deprovisioned from the app 236.

In some implementations, the ELM logic 200 itself is configured to carry out the deprovisioning of users from the app 236. In some implementations the ELM logic 200 accesses the app 236 directly to deprovision a given user from the app 236, such as by accessing an API 238 of the app 236. However, it will be appreciated that some customers of the SMP 100 may actually manage their users' access to the app 236 (and others) via the SSO 240. Accordingly, in some implementations the ELM logic 200 includes SSO integration logic 206 that is configured to carry out deprovisioning of a given user by accessing an API 242 of the SSO 240.

It will be appreciated that the steps required to deprovision a given user via the SSO 240 can be varied and complicated depending upon the organizational constructs defined by the SSO 240, such as various user groups which govern app licensing. Hence, the SSO integration logic 206 can be configured to access the API 242 of the SSO 240 to retrieve data identifying the configuration of user groups in the SSO 240, analyze the configuration to determine what steps are needed to deprovision a user, and then carry out deprovisioning of the user from the app 236, for example, by accessing the API 242 of the SSO 240. In some implementations, the SSO 240 uses System for Cross-domain Identity Management (SCIM) to deprovision the user from the app 236. Certain examples of processes required to deprovision a given user based on specific user group configurations are discussed by way of illustration further below.

By communicating with the SSO 240 to carry out deprovisioning, conflicts between the app 236 and the SSO 240 can be avoided. For example, if a user is deprovisioned by directly communicating with the app 236, when the customer's licenses for the app 236 are in fact managed via the SSO 240, then the deprovisioning of the user directly from the app 236 may cause conflict because in the SSO 240 the user may still be configured to be provisioned for the app 236. And furthermore, the SSO 240 may even reprovision the user upon determining that the user is unable to login, thereby contravening the intent of the customer. Thus, when a given customer uses an SSO system to manage their provisioning of licenses for apps, integration with the SSO is beneficial for avoiding conflicts with such apps, and aligns with the customer's use of the SSO.

In some implementations, the ELM logic 200 is configured to notify a user when it is determined that their license for the app 236 should be deprovisioned. To this end, notification logic 204 is configured to generate and send the notification to the user, such as by sending an email, a direct message, a text message, a chat message, social media message, or other form of message or notification to the user. The notification logic 204 can be configured to access a messaging service 248 (e.g. email service, collaboration platform messaging service, etc.) in order to send the notification or message to the user. In some implementations, such a notification will inform the user that they have been deprovisioned from the app 236 in the case that the ELM logic 200 automatically deprovisions the user.

In other instances, the notification can be sent before taking action, so as to provide the user with notice that their license might be taken away based on their lack of use of the app 236. For example, a notification can be generated that asks the user to confirm whether they wish to keep or maintain their license for the app 236. In some implementations, such a notification can include a response mechanism such as one or more buttons that the user may click on to respond. Accordingly, if the user responds in the affirmative, then their license will be maintained, whereas if the user responds in the negative, then the user will be deprovisioned. In some implementations, if the user does not respond within a specified time period, then the user will be deprovisioned as well.

In some implementations, the above-described provisioning settings 228, which identify what criteria are used to determine which users should be deprovisioned, and what action to take when such users are identified, define a “workflow” that is executable by the ELM logic 200. Such a workflow can be defined by the customer and executed on-demand or on a schedule. To this end, scheduling settings 234 are configurable by the customer to define a schedule for automatically running a workflow established by the provisioning settings 228. By way of example without limitation, the scheduling settings 234 might be configured to run the workflow once a month (e.g. on the first day of the month), once a quarter, once every 60 days, on the first of the month every other month, once every x number of months/weeks/days, every nth pay period, etc.

In some instances, a customer may wish to understand which users ought to be deprovisioned from the app 236, and may not want the SMP 100 to automatically take action to deprovision such users. Accordingly, in some implementations, a customer access API 208 is provided to enable the customer to access functionality of the ELM logic 200.

As shown in the illustrated implementation, the customer access API 208 is accessed by a customer device 244 through a user interface 246 rendered by the customer device 244 and operated by a user (e.g. an administrative user of the customer). In some implementations, the customer access API 208 is configured to enable on-demand running of the usage analyzer 202 to determine, based on the provisioning settings 228 as described above, which users should be deprovisioned from the app 236. The results of such analysis are published via the API 208, and can include the app usage analysis results for the users, and identify which users ought to be deprovisioned.

It will be appreciated that various pieces of data can be made available to the customer, such as the identities of users that are determined should be deprovisioned, and the login history or usage data upon which such determinations were made. Additionally, in some implementations, the customer access API 208 provides access to information describing what particular action should be taken in order to deprovision a given user. By way of example, such information may describe a license or access user group to which the user belongs, that the user should be removed from, that the user should be added to, and/or other types of user group related actions that should be taken in order to deprovision the user (such as creating a new user group, deleting an old user group, migrating users from one group to another, etc.).

In some implementations, the analysis of app usage can be performed on a predefined schedule, and the results and recommendations from such analysis are stored and made accessible to the customer through the customer access API 208.

While the management of license provisioning through use of the ELM logic 200 and provisioning settings 228 has been described, in further implementations, additional aspects of elastic license management are provided. Similar to the provisioning settings 228, as shown in the illustrated implementation, license tier settings 230 can also be defined for the management of which license tiers users are assigned (e.g. for the app 236), and permission settings 232 can be defined for the management of which permission types users are given.

It will be appreciated that a given app 236 may have several license tiers with different features of the app enabled for different license tiers. Generally, a lower license tier will have fewer features enabled or features that are enabled to a lesser extent (e.g. fewer number of uses of a given feature, less time of use of a given feature, etc.), whereas a higher license tier will have more features enabled or features that are enabled to a greater extent (e.g. greater number of uses of a given feature, higher time of use of a given feature, etc.). Naturally, a higher license tier will generally cost more than a lower license tier. In some instances, different license tiers are not necessarily higher or lower than each other, but may encompass different feature sets, and have different costs. While the availability of different license tiers provides options for the customer to purchase licenses suited to their desired features, they also present a problem in that a given user may not be optimally provisioned at a license tier having the appropriate features to suit their actual use. Or the user's usage of features may change over time, and what was once the right license tier may no longer be the best fit for the user. When the license tier is too high, then the customer is overpaying for features that are not being used. Whereas when the license tier is too low, or the feature availability is insufficient for the user, then the user can be frustrated because they lack the tools to be optimally productive. In view of these issues, implementations of the present disclosure enable elastic license management that is capable of determining the optimal license tier for a user and adjusting their license tier if necessary.

License tier settings 230 define what parameters are used to determine whether a user should have their license tier for the app 236 changed (e.g. downgraded, upgraded, switched to a different license tier). For example, the parameters may define that a user should be downgraded from a higher license tier to a lower license tier if they have not used a feature that is included in the higher license tier (but not included in the lower license tier) within a specified prior time period (e.g. within the past N number of days/weeks/months, within the past 60 days, within the past 10 weeks, within the past 3 months, etc.), or if they have used a feature less than a predefined amount (e.g. number of times) within a specified prior time period (e.g. the predefined amount being near, at, or above a limit of the lower license tier, above which the higher license tier is required), or if they have used a feature at a rate less than a predefined rate within a specified prior time period (e.g. the predefined rate being near, at, or above a rate limit of the lower license tier, above which the higher license tier is required), etc.

In some implementations, the parameters of the license tier settings 230 may define that a user should be upgraded from a lower license tier to a higher license tier if their use of a feature exceeds a predefined amount within a specified prior time period (e.g. the predefined amount being proximate to a limit of the lower license tier, above which the higher license tier is required), or if they have used a feature at a rate exceeding a predefined rate within a specified prior time period (e.g. the predefined rate being proximate to a rate limit of the lower license tier, above which the higher license tier is required), or if their use of a feature is increasing over time with a trajectory suggesting they will soon exceed a limit of the lower license tier, etc.

In some implementations, the parameters of the license tier settings 230 may define that a user should be switched from one license tier to another license tier based on their usage of features of the app 236. For example, the parameters may define ranges or thresholds of use of various features of the app 236, and usage of the features over a specified prior time period that falls within such ranges, or exceeds or does not exceed such thresholds, can be configured to indicate that a user should be switched from one license tier to another license tier.

As with the provisioning settings described above, the license tier settings 230 further define what should happen when it is determined that a user should be downgraded to a lower license tier, upgraded to a higher license tier, or switched to a different license tier of the app 236. For example, in some implementations the license tier settings 230 define that the user will be notified via a designated communications channel or mechanism, such as through an email, chat, text message, direct message, or other electronic message. In some implementations, the license tier settings 230 define that the user will have their license tier changed by the SMP itself. It will be appreciated that in some implementations, the license tier settings 230 may not define a specific action to be taken as a result of determining that a user's license tier should be changed. However, the result of such a determination is stored, and can be retrieved by the customer as further described herein.

In view of the above, as with the provisioning settings 228 previously described, the license tier settings are accessed by the ELM logic 200 to carry out license management activities on behalf of the customer. More specifically, the usage analyzer 202 is configured to analyze users' usage of the app 236 in accordance with the license tier settings 230 to determine which users should have their license tier changed for the app 236. In some implementations, the users' app usage data is obtained from the customer usage data 112, which includes feature level usage data. Thus in accordance with the license tier settings 230 as described above, the usage analyzer 202 can be configured to determine which users should have their license tier changed, for example, based on whether or not they have used a given feature within a specified prior time period. For example, users that have not used a feature enabled in a higher license tier within the last 60 days may be considered to be users that ought to be downgraded to a lower license tier of the app 236. As another example, users that have reached a feature usage limit of a lower license tier within the last 60 days may be considered to be users that ought to be upgraded to a higher license tier of the app 236.

In some implementations, the ELM logic 200 itself is configured to carry out the changing of users' license tiers for the app 236. In some implementations the ELM logic 200 accesses the app 236 directly to change the license tier of a given user of the app 236, such as by accessing the API 238 of the app 236. However, as has been noted, some customers of the SMP 100 may actually manage their users' licensing for the app 236 (and others) via the SSO 240. Accordingly, in some implementations the SSO integration logic 206 of the ELM logic 200 is configured to carry out changing of the license tier of a given user by accessing the API 242 of the SSO 240.

As with deprovisioning via SSO, it will be appreciated that the steps required to change the license tier of a given user via the SSO 240 can be varied and complicated depending upon the organizational constructs defined by the SSO 240, such as various existing user groups which may or may not govern app licensing. Hence, the SSO integration logic 206 can be configured to access the API 242 of the SSO 240 to retrieve data identifying the configuration of user groups in the SSO 240, analyze the configuration to determine what steps are needed to change the license tier of a user, and then carry out the necessary changes to the configuration in order to effect changing the license tier of the user for the app 236, for example, by accessing the API 242 of the SSO 240. In some implementations, the SSO 240 uses SCIM to change the license tier of the user. Certain examples of processes required to change the license tier of a given user based on specific user group configurations are discussed by way of illustration further below.

Similar to the case of deprovisioning as discussed above, by communicating with the SSO 240 to carry out license tier changes, it will be appreciated that conflicts between the app 236 and the SSO 240 can be avoided.

In some implementations, the ELM logic 200 is configured to notify a user when it is determined that their license tier of the app 236 should be changed. To this end, notification logic 204 is configured to generate and send the notification to the user, such as by sending an email, a direct message, a text message, a chat message, social media message, or other form of message or notification to the user. The notification logic 204 can be configured to access a messaging service 248 (e.g. email service, collaboration platform messaging service, etc.) in order to send the notification or message to the user. In some implementations, such a notification will inform the user that their license tier of the app 236 has been changed, in the case that the ELM logic 200 automatically implements such a change.

In other instances, the notification can be sent before taking action, so as to provide the user with notice that their license tier may be changed, or is recommended to be changed.

For example, if it is determined that a user's license tier should be downgraded (e.g. based on lack of use of features), then a notification can be generated that asks the user to confirm whether they wish to keep or maintain their existing license tier for the app 236. In some implementations, such a notification can include a response mechanism such as one or more buttons that the user may click on to respond. Accordingly, if the user responds in the affirmative, then their existing license tier will be maintained, whereas if the user responds in the negative, then the user's license tier will be downgraded to a lower license tier. In some implementations, if the user does not respond within a specified time period, then the user will be automatically downgraded as well.

In another example, if it is determined that a user's license tier should be upgraded (e.g. based on use of features approaching or reaching limits), then a notification can be generated that asks the user to confirm whether they wish to upgrade their license tier for the app 236. In some implementations, such a notification can include a response mechanism such as one or more buttons that the user may click on to respond. In some implementations, if the user responds in the affirmative, then their license tier will be upgraded, or a request (e.g. request/message to manager or IT administrator, or open a ticket request to upgrade, etc.) will be submitted on their behalf to upgrade their license tier, whereas if the user responds in the negative, then the user's license tier will be maintained.

In some implementations, the above-described license tier settings 230, which identify what criteria are used to determine which users should change license tiers, and what action to take when such users are identified, define a “workflow” that is executable by the ELM logic 200. Such a workflow can be defined by the customer and executed on-demand, or on a schedule. To this end, scheduling settings 234 are configurable by the customer to define a schedule for automatically running a workflow established by the license tier settings 230. By way of example without limitation, the scheduling settings 234 might be configured to run the workflow once a month (e.g. on the first day of the month), once a quarter, once every 60 days, on the first of the month every other month, once every x number of months/weeks/days, every nth pay period, etc.

In some instances, a customer may wish to understand which users of the app 236 ought to change license tiers, and may not want the SMP 100 to automatically take action to change such users. Accordingly, in some implementations, the customer access API 208 is provided to enable the customer to access functionality of the ELM logic 200 as has been discussed. For example, in some implementations, the customer access API 208 is configured to enable on-demand running of the usage analyzer 202 to determine, based on the license tier settings 230 as described above, which users should change license tiers for the app 236. The results of such analysis are published via the API 208, and can include the app usage analysis results for the users, and identify which users ought to change license tiers and how.

It will be appreciated that various pieces of data can be made available to the customer, such as the identities of users that are determined should change license tiers, and the usage data history upon which such determinations were made. Additionally, in some implementations, the customer access API 208 provides access to information describing what particular action should be taken in order to change the license tier of a given user. By way of example, such information may describe a license or access user group to which the user belongs, that the user should be removed from, that the user should be added to, and/or other types of user group related actions that should be taken in order to change the license tier of the user (such as creating a new user group, deleting an old user group, migrating users from one group to another, etc.).

In some implementations, the analysis of app usage can be performed on a predefined schedule, and the results and recommendations from such analysis are stored and made accessible to the customer through the customer access API 208.

While the management of license provisioning and license tiers through use of the ELM logic 200 and provisioning settings 228 and license tier settings 230 has been described, in further implementations, the elastic license management systems of the present disclosure also enable management of user permissions (sometimes referred to as user types). In a similar manner to the provisioning settings 228 and license tier settings 230, as shown in the illustrated implementation, permission settings 232 can be defined for the management of which permission types users are given (e.g. for the app 236).

It will be appreciated that a given app 236 may have several permission types/levels with different features or actions made permissible/impermissible or enabled/disabled depending upon the particular permission type. By way of example without limitation, the app 236 might have various permission types for users such as a basic user, a power user, and an administrative user. Generally, a lower permission level will have fewer features enabled, whereas a higher permission level will have more features enabled. While the availability of different permission levels provides options for the customer to provide their users with varying abilities within the app, they also present a problem in that a given user may have too high or too low a permission level. Or the user's usage of features may change over time, and what was once the right permission level may no longer be the best fit for the user. When the permission level is too high, this poses a security issue, for if the user's account is hacked or otherwise compromised, then a malicious actor could gain access to more sensitive information, or cause more significant harm, than would otherwise be the case had the permission level been lower. In the opposite scenario when the permission level is too low, then feature availability may be insufficient for the user, and the user can be frustrated because they lack the tools to be optimally productive. In view of these issues, implementations of the present disclosure enable elastic license management that is capable of determining the optimal permission level for a user and adjusting their permission level if necessary.

Permission settings 232 define what parameters are used to determine whether a user should have their permission level for the app 236 changed (e.g. downgraded or upgraded). For example, the parameters may define that a user should be downgraded from a higher permission level to a lower permission level if they have not used a feature that is included in the higher permission level (but not included in the lower permission level) within a specified prior time period (e.g. within the past N number of days/weeks/months, within the past 60 days, within the past 10 weeks, within the past 3 months, etc.). In some implementations, the parameters of the permission settings 232 may define that a user should be upgraded from a lower permission level to a higher permission level if their use of the app within a specified prior time period indicates a need for features of the higher permission level. For example, attempts by the user to access features of the higher permission level may be detected and logged, and may indicate that the user should have their permission level upgraded.

As with the provisioning and license tier settings described above, the permission settings 232 further define what should happen when it is determined that a user should be downgraded to a lower permission level, or upgraded to a higher permission level. For example, in some implementations the permission settings 232 define that the user will be notified via a designated communications channel or mechanism, such as through an email, chat, text message, direct message, or other electronic message. In some implementations, the permission settings 232 define that the user will have their permission level changed by the SMP itself. It will be appreciated that in some implementations, the permission settings 232 may not define a specific action to be taken as a result of determining that a user's permission level should be changed. However, the result of such a determination is stored, and can be retrieved by the customer as further described herein.

In view of the above, as with the provisioning settings 228 and license tier settings 230 previously described, the usage analyzer 202 of the ELM logic 200 is configured to analyze users' usage of the app 236 in accordance with the permission settings 232 to determine which users should have their permission level changed for the app 236. In some implementations, the users' app usage data is obtained from the customer usage data 112, which includes feature level usage data. Thus in accordance with the permission level settings 232 as described above, the usage analyzer 202 can be configured to determine which users should have their permission level changed, for example, based on whether or not they have used a given feature within a specified prior time period. For example, administrative users that have not used an administrative feature within the last 60 days may be determined to be users that ought to be downgraded to a lower permission level of the app 236.

In some implementations, the ELM logic 200 itself is configured to carry out the changing of users' permission levels for the app 236. In some implementations the ELM logic 200 accesses the app 236 directly to change the permission level of a given user of the app 236, such as by accessing the API 238 of the app 236. However, as has been noted, some customers of the SMP 100 may actually manage their users' licensing for the app 236 (and others) via the SSO 240. Accordingly, in some implementations the SSO integration logic 206 of the ELM logic 200 is configured to carry out changing of the permission level of a given user by accessing the API 242 of the SSO 240.

As with deprovisioning via SSO, it will be appreciated that the steps required to change the permission level of a given user via the SSO 240 can be varied and complicated depending upon the organizational constructs defined by the SSO 240, such as various existing user groups which may or may not govern user permissions. Hence, the SSO integration logic 206 can be configured to access the API 242 of the SSO 240 to retrieve data identifying the configuration of user groups in the SSO 240, analyze the configuration to determine what steps are needed to change the permission level of a user, and then carry out the necessary changes to the configuration in order to effect changing the permission level of the user for the app 236, for example, by accessing the API 242 of the SSO 240. In some implementations, the SSO 240 uses SCIM to change the permission level of the user. Certain examples of processes required to change the permission level of a given user based on specific user group configurations are discussed by way of illustration further below.

Similar to the case of deprovisioning as discussed above, by communicating with the SSO 240 to carry out permission level changes, it will be appreciated that conflicts between the app 236 and the SSO 240 can be avoided.

In some implementations, the ELM logic 200 is configured to notify a user when it is determined that their permission level for the app 236 should be changed. To this end, notification logic 204 is configured to generate and send the notification to the user, such as by sending an email, a direct message, a text message, a chat message, social media message, or other form of message or notification to the user. The notification logic 204 can be configured to access a messaging service 248 (e.g. email service, collaboration platform messaging service, etc.) in order to send the notification or message to the user. In some implementations, such a notification will inform the user that their permission level for the app 236 has been changed, in the case that the ELM logic 200 automatically implements such a change.

In other instances, the notification can be sent before taking action, so as to provide the user with notice that their permission level may be changed, or is recommended to be changed.

For example, if it is determined that a user's permission level should be downgraded (e.g. based on lack of use of features specific to the user's current permission level), then a notification can be generated that asks the user to confirm whether they wish to keep or maintain their existing permission level for the app 236. In some implementations, such a notification can include a response mechanism such as one or more buttons that the user may click on to respond. Accordingly, if the user responds in the affirmative, then their existing permission level will be maintained, whereas if the user responds in the negative, then the user's permission level will be downgraded to a lower permission level. In some implementations, if the user does not respond within a specified time period, then the user will be automatically downgraded as well.

In another example, if it is determined that a user's permission level should be upgraded (e.g. based on attempts to use certain features requiring a higher permission level), then a notification can be generated that asks the user to indicate whether they wish to upgrade their permission level for the app 236. In some implementations, such a notification can include a response mechanism such as one or more buttons that the user may click on to respond. In some implementations, if the user responds in the affirmative, then their permission level will be upgraded, or a request (e.g. request/message to manager or IT administrator, or open a ticket request to upgrade, etc.) will be submitted on their behalf to upgrade their permission level, whereas if the user responds in the negative, then the user's permission level will be maintained.

In some implementations, the above-described permission settings 232, which identify what criteria are used to determine which users should change permission levels, and what action to take when such users are identified, define a “workflow” that is executable by the ELM logic 200. Such a workflow can be defined by the customer and executed on-demand, or on a schedule. To this end, scheduling settings 234 are configurable by the customer to define a schedule for automatically running a workflow established by the permission settings 232. By way of example without limitation, the scheduling settings 234 might be configured to run the workflow once a month (e.g. on the first day of the month), once a quarter, once every 60 days, on the first of the month every other month, once every x number of months/weeks/days, every nth pay period, etc.

In some instances, a customer may wish to understand which users of the app 236 ought to change permission levels, and may not want the SMP 100 to automatically take action to change such users. Accordingly, in some implementations, the customer access API 208 is provided to enable the customer to access functionality of the ELM logic 200 as has been discussed. For example, in some implementations, the customer access API 208 is configured to enable on-demand running of the usage analyzer 202 to determine, based on the permission settings 232 as described above, which users should change permission levels for the app 236. The results of such analysis are published via the API 208, and can include the app usage analysis results for the users, and identify which users ought to change permission levels and how.

It will be appreciated that various pieces of data can be made available to the customer, such as the identities of users that are determined should change permission levels, and the usage data history upon which such determinations were made. Additionally, in some implementations, the customer access API 208 provides access to information describing what particular action should be taken in order to change the permission level of a given user. By way of example, such information may describe a license or access user group to which the user belongs, that the user should be removed from, that the user should be added to, and/or other types of user group related actions that should be taken in order to change the permission level of the user (such as creating a new user group, deleting an old user group, migrating users from one group to another, etc.).

In some implementations, the analysis of app usage can be performed on a predefined schedule, and the results and recommendations from such analysis are stored and made accessible to the customer through the customer access API 208.

Though the present implementations of elastic license management enable automatic activity to be taken with respect to a user's provisioning, license tier, and permission type for the app 236 as has been described, it will be appreciated that in some implementations it is useful to exempt certain users from such changes. Accordingly, in some implementations the app specific settings 222 can further include a static exempt list 224 as well as a dynamic exempt list 226. The static exempt list 224 is configurable to list specific users that are exempt from changes to their provisioning, license tier, and/or permission level, for the app 236. For example, an administrative user of the customer such as an IT manager may add specific user identifiers (IDs) of users to the static exempt list 224, and configure which types of changes they are exempt from. Examples of a user ID can be an email address, a user ID associated with the SaaS management platform 100, a user ID associated with the SSO 240, an employee ID associated with the customer organization, etc.

In contrast to the static exempt list 224 which identifies specific users, the dynamic exempt list 226 is configurable to identify types or categories or characteristics of users that will be exempt from changes to their provisioning, license tier, or permission settings with respect to the app 236. For example, the dynamic exempt list 226 can be configured to list certain roles, titles, job functions, teams, groups, job levels, locations, seniority, length of tenure, or other organizational or employee-related characteristics/categories that will be exempt from changes in one or more of their settings for the app 236. Thus in contrast to the static exempt list 224 which lists specific users who are exempt, the dynamic exempt list 226 is dynamic in the sense that the specific users that are exempt by virtue of the dynamic exempt list's definition are dynamically determined by considering the characteristics of the users at the present time. As an example, a user might be in a role that is not exempt, but then transition to a new role that is exempt, and hence their exempt status changes in a dynamic manner based on their role. As another example, the app 236 might be a core app for the sales team, and accordingly one might add the sales team to the dynamic exempt list 226 so that any user that is a member of sales will be exempt from deprovisioning from the app 236, but not necessarily exempt from license tier changes or permission level changes. As users join or leave the sales team, the specific users that are exempt as a result will dynamically change over time. As another example, the dynamic exempt list 226 could be configured to specify that all users who are VP level and above are exempt from any changes to their settings for the app 236.

In some implementations, the dynamic exempt list 226 can be configured to exempt users that have been provisioned for the app 236 for less than a specified length of time, such as less than a specified number of days (e.g. 30, 45, or 60 days), less than a specified number of weeks, less than a specified number of months, etc. For newly provisioned users of an app may need sufficient time to engage with the app before determinations about whether their provisioning, license tier, and/or permission level are appropriate can be made.

In view of the above, it will be appreciated that the ELM logic 200 will consider a given user and determine whether the user is listed on the static exempt list 224 or if the characteristics of the given user are identified in the dynamic exempt list 226, and if so, then the given user will be ignored or otherwise exempted from changes to one or more of their settings with respect to the app 236. For the given user, HR data 210 is accessed to determine the relevant characteristics of the user (e.g. their role, team, location, etc.) and whether they match those listed in the dynamic exempt list 226.

In addition to the static and dynamic exempt lists 224 and 226 that are part of the app-specific settings 222 and pertain to the app 236, there can be global exempt lists defined as part of global settings 216 which are applied across all apps that are managed in accordance with the elastic license management systems presently described. More specifically, similar to the app-specific static exempt list 224, a global static exempt list 218 can be configured to list specific users that are exempt from changes to one or more of their settings with respect to all apps. For example, one might list the user ID of the CEO of the customer on the global static exempt list 218, to be exempt from changes to their provisioning, license tier, and or permissions across all apps.

Additionally, similar to the app-specific dynamic exempt list 226, a global dynamic exempt list 220 can be configured to list characteristics or categories of users that are exempt from changes to one or more of their settings with respect to all apps. For example, one might specify In the global dynamic exempt list 220 that all C-level (e.g. CEO, COO, CIO, CTO, etc.) employees are exempt from changes to one or more of their settings with respect to all apps. As another example, one might specify through the global dynamic exempt list 220, that any employee that has been employed with the customer organization for less than a specified amount of time (e.g. X number of days, weeks, etc.) will be exempt from changes in their settings with respect to all apps. As yet another example, one might specify that an employee that is currently on leave (e.g. vacation, sabbatical, leave of absence, maternity leave, paid time off, etc.) will be exempt from changes in their settings with respect to all apps. As with the app-specific dynamic exempt list 226 described above, it will be appreciated that the ELM logic 200 accesses HR data 210 to determine for a given user whether they have characteristics or categorizations meeting criteria, as defined by the global dynamic exempt list 220, that establishes the given user as exempt from one or more changes in their settings.

In some implementations, integration with HR data further enables different elastic license management behaviors to be configured for different types of users based on their HR data characteristics. For example, the provisioning, license tier, and/or permissions settings, can be configured so that certain users receive notifications before a change is made to their license (e.g. giving an option to opt out), whereas other users are automatically changed (and may be notified, but without an option to opt out). For example, for a sales app, one might configure the system so that members of the sales team receive notifications with an option to maintain their license or license tier before being deprovisioned or downgraded, whereas others that are not members of the sales team do not receive such a notification before being deprovisioned or downgraded. As another example, a customer might configure the system so that users at a specified job level and above receive notifications with an option to opt out before any change is made to their license, whereas users below the specified job level do not receive the option to opt out.

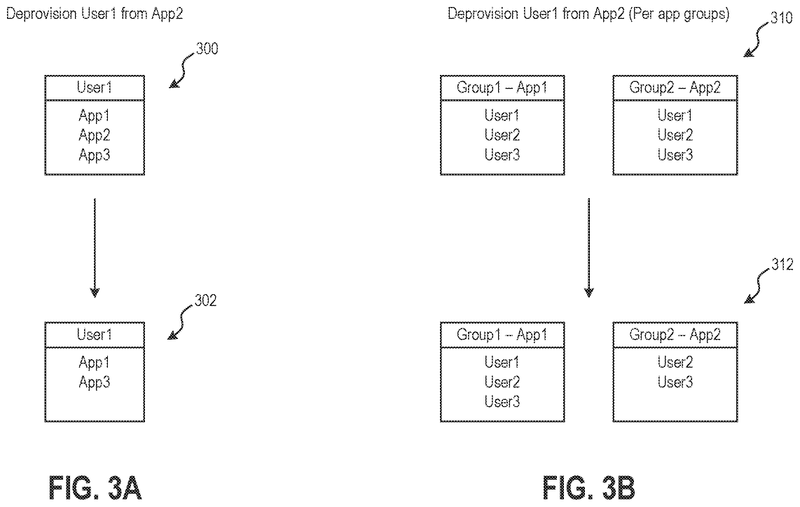

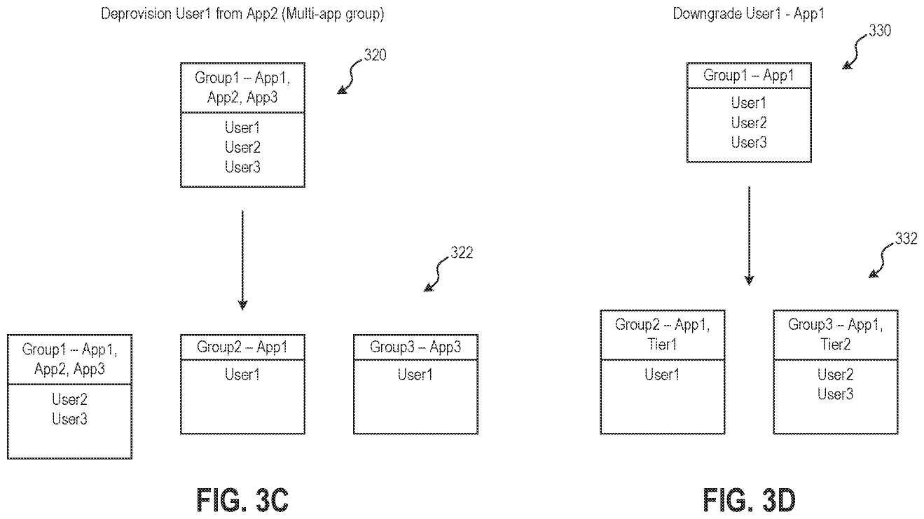

As noted above, in some implementations, the ELM logic 200 implements SSO integration logic 206 to manage app licensing changes via the SSO 240. Because the particular organizational structuring of users implemented by the SSO can vary, it is necessary to understand how users and licensing are organized by the SSO, before a particular action such as deprovisioning or changing license tiers can be carried out. Accordingly, FIGS. 3A, 3B, 3C, and 3D conceptually illustrate various example scenarios of organizational structures utilized for app license management by an SSO, in accordance with implementations of the disclosure. The illustrated examples are provided by way of example without limitation, to illustrate the principles of the present disclosure in this regard.

FIG. 3A conceptually illustrates an implementation in which the SSO assigns apps to users on an individual basis. That is, each user is separately managed in terms of their provisioning for each app. Thus, as shown in the illustrated implementation, a user “User1” is assigned various apps “App1,” “App2,” and “App3,” indicating that User1 is provisioned for each of these apps. Accordingly, in order to deprovision User1 from App2, for example, then removal of the assignment of App2 to User1 is performed as conceptually shown. When the assignment of App2 is removed from User1, then User1 will be deprovisioned from the App2. While provisioning and deprovisioning of apps has been described, it will be appreciated that in other implementations, license tiers and permissions can be assigned to users individually in a similar fashion. It will be appreciated that under such a setup, management of provisioning, license tiers, and/or permissions can be handled by assignment and/or removal of assignment from a user.

FIG. 3B conceptually illustrates an implementation in which the SSO assigns users to various user groups in order to determine provisioning for apps. In the illustrated implementation, user groups are defined, with each user group identifying the users that are provisioned for a given app. A user group “Group1” is defined for an app “App1,” so that users assigned to “Group1” are provisioned for App1; and a user group “Group2” is defined for an app “App2,” so that users assigned to Group2 are provisioned for App2. Accordingly as shown, in order to deprovision User1 from App2, then User1 is removed from Group2 in the SSO. While provisioning and deprovisioning of apps has been described, it will be appreciated that in other implementations, license tiers and permissions can be managed by assigning users to specific user groups in a similar fashion. For example, a given user group may be defined for users that are provisioned for an app at a given license tier and/or permission level, while a different user group may be defined for users provisioned for the app at a different license tier and/or permission level, etc. It will be appreciated that under such a setup, management of provisioning, license tiers, and/or permissions can be handled by adding or removing a user from the relevant user group.

FIG. 3C conceptually illustrates an implementation in which the SSO assigns users to various user groups in order to determine provisioning for apps. More specifically, a multi-app user group is configured to define provisioning for a plurality of apps simultaneously, so that members of the user group are provisioned for each of the plurality of apps. In the illustrated implementation, the user group “Group1” is configured to govern provisioning for several apps “App1,” “App2,” and “App3.” As shown, users “User1,” “User2,” and “User3” are members of Group1, and are therefore provisioned for App1, App2, and App3. However, this configuration complicates the process of deprovisioning a user from just one of the apps, as removing a user from the group will result in deprovisioning of the user from all of the apps. For example, in order to deprovision User1 from App2, then as an initial step User1 is removed from Group1. But in order to ensure that User1 continues to be provisioned for App1 and App3, then User1 is added to another user group “Group2” that determines provisioning for App1, and User1 is also added to another user group “Group3” that determines provisioning for App3. In some implementations, if Group2 or Group3 do not exist then they are first created in the SSO. It will be appreciated that in the process of adding User1 to Group2 and Group3, it is important to maintain User1's license and account information for App1 and App3, so that User1 does not lose any data or experience any interruption in their usage of App1 and App3 (such as would occur if User1 were deprovisioned and then reprovisioned for App1 and App3). It will be appreciated that in other implementations, the concepts presently described can be extended to handle changing of license tiers and/or permissions.

FIG. 3D conceptually illustrates an implementation in which the SSO assigns users to a user group in order to determine provisioning for an app. More specifically, in the illustrated implementation, the user group “Group1” is configured to govern provisioning for an app “App1.” As shown, users “User1,” “User2,” and “User3” are members of Group1, and are therefore provisioned for App1. However, Group1 does not distinguish between license tiers of App1, and therefore if seeking to change license tiers of a given user, then it may be desirable to configure different user groups for different license tiers. For example, in the illustrated implementation, when downgrading User1 from a higher license tier (e.g. “Tier2”) to a lower license tier (e.g. “Tier1”), then in place of Group1, new groups “Group2” and “Group3” are created, with Group2 being configured for members provisioned for App1 at the Tier1 level, and Group3 defining members provisioned for App1 at the Tier2 level. In this case, User1 has been added to Group2, thereby downgrading User1 to the Tier2 level, while User2 and User3 have been added to Group3, thereby maintaining their licenses at the Tier2 level.

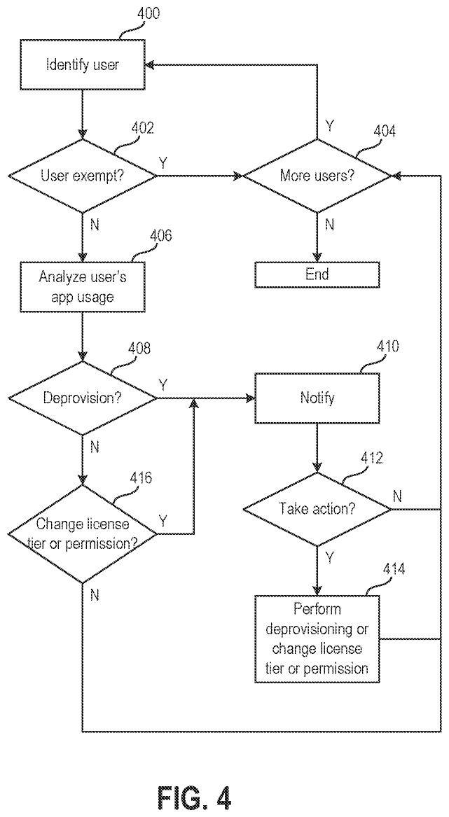

FIG. 4 conceptually illustrates a method for performing elastic license management for one or more users, in accordance with implementations of the disclosure.

The illustrated method can be performed for a group of users, such as those of a particular customer of the SMP 100. The method initiates at method operation 400 with identifying a given user, such as an employee of a customer, or a particular user of a given app. At method operation 402, it is determined whether the identified user is exempt from changes to their provisioning status with respect to the given app, which may include exemption from deprovisioning, exemption from changes to license tier, and/or exemption to changes in permissions. As described above, the user's exempt status may be determined with reference to one or more exempt lists, including static and dynamic exempt lists, which may be app-specific or global. As noted, HR data of the user may be obtained in order to determine whether the user is exempt based on certain dynamic exempt list parameters. If the identified user is exempt from any changes to their provisioning status, then at method operation 404 it is determined whether there are additional users to consider. If so, then the method returns to method operation 400; if not, then the method ends.

If the identified user is not exempt from any changes, then at method operation 406, the user's app usage is analyzed. The analysis can entail obtaining feature-level usage data for the given app and user, and may be based on various settings regarding provisioning, license tier, and permissions as has been described. At method operation 408, it is determined based on the analysis whether the user should be deprovisioned (assuming the user is not exempt from deprovisioning). If so, then at method operation 410, a notification is sent to the user. The notification may inform the user that they will be deprovisioned from the app unless the user affirmatively opts to keep their license for the app. As described, the notification may include a response mechanism for the user to indicate they wish to keep the app. At method operation 412, it is determined whether the system should take action, in this case, to carry out deprovisioning of the user. For example, if the user has not provided a response to the notification within a specified time period indicating that they wish to keep their license for the app, then at method operation 414, the deprovisioning is performed, such as by accessing the app directly or by accessing an SSO system to carry out the deprovisioning.

In other implementations, the notification informs the user that they will be deprovisioned. In some implementations, the performance of the deprovisioning occurs automatically after determining that the user should be deprovisioned. In other implementations, the system is configured not to take action, but rather the results of the analysis of the user's app usage data indicating that the user should be deprovisioned, are stored and capable of being provided as a recommendation and/or retrieved on-demand, e.g. via the customer access API).

When it is determined at method operation 408 that the user should not be deprovisioned, then at method operation 416 it is further determined whether the user's license tier should be changed, and/or whether the user's permission level should be changed. These determinations are based on the analysis of the user's usage data, which may be performed in accordance with predefined settings as has been discussed. If it is determined that the user's license tier/type should be changed, and/or the user's permission level should be changed, then the method proceeds to method operation 410, wherein a notification is sent to the user. In some implementations, the notification informs the user of the change to their license tier or permissions, whereas in other implementations, the notification may inform the user of the determination that their license tier or permission level should be changed, and may give the user the chance to opt out of the change to their license tier or permission level through a response mechanism.

At method operation 412, it is determined whether the system should take action, in this case, to carry out changing of the license tier or permission level of the user. For example, if the user has not provided a response to the notification within a specified time period indicating that they wish to opt out of the change (e.g. by keeping their current license tier or permission level), then at method operation 414, the action is performed, such as by accessing the app directly or by accessing an SSO system to carry out the action.

In the case where it is determined not to take action at method operation 412, or after an action is performed at method operation 414, then the method returns to method operation 404 to determine whether there are additional users to consider. If so, then the method returns to method operation 400; if not, then the method ends.

In some implementations, in the systems and methods presently described, the determination that a given user should be deprovisioned, and/or have their license tier and/or permission level changed, defines a target provisioning status for the given user. And accordingly, various courses of action can be taken in response to the target provisioning status, such as notifying the user, and/or performing the necessary actions to change the user's current provisioning status to the target provisioning status.

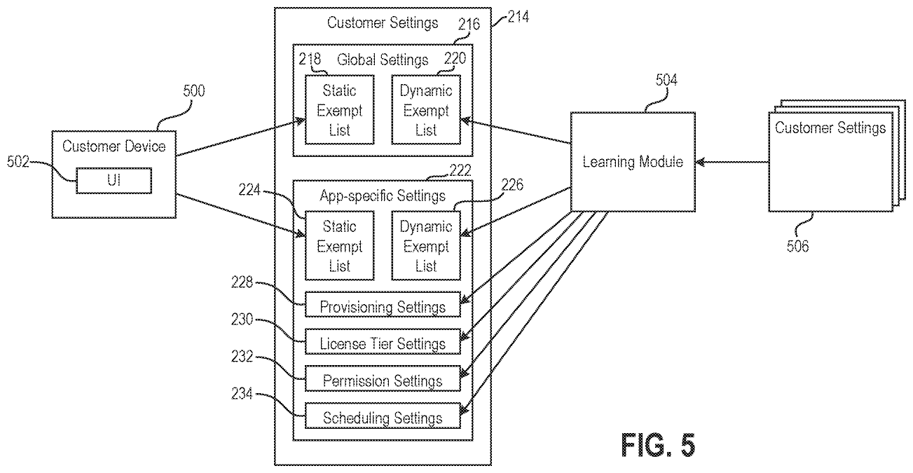

FIG. 5 conceptually illustrates methods for configuring global and app-specific settings for a given customer, in accordance with implementations of the disclosure.

It will be appreciated that the customer settings 214 can be configured by the customer (e.g. an administrative user, IT manager/employee, etc.) via a user interface 502 presented by a customer device 500. In some implementations, the user interface 502 for editing customer settings is part of the user interface of the SMP 100. It will be appreciated that the customer may configure any of the global and app-specific settings. For example, the customer may edit the static exempt lists by adding or removing specific users from the static exempt lists, through the user interface 502.

Additionally, in some implementations, certain settings can be learned by the SMP 100 based on the settings applied by its various customers. In the illustrated implementation, a learning module 504 is configured to analyze the customer settings 506 of the SMP's various customers to determine certain preferred settings amongst the SMP's customers. For example, the learning module 504 may identify commonly or frequently used configurations for any of the global dynamic exempt list 220, the app-specific dynamic exempt list 226, the provisioning settings 228, the license tier settings 230, the permissions settings 232, and the scheduling settings 234. In some implementations, the learned configurations can be provided or suggested as default settings for a given customer during configuration of the customer's specific elastic license management settings.

In some implementations, the learning module 504 employs a machine learning model trained using the customer settings 506 to determine or predict customer elastic license management settings. In various implementations, a machine learning model can be trained to identify which users should be deprovisioned, or which license tier users ought to be set at, or which permission level users ought to be set at, based on their usage data, HR data, or other characteristics. In some implementations, the machine learning model is trained using logged changes to provisioning, license tiers, and/or permissions of users by a given customer. That is, as a given customer (e.g. an IT admin) executes changes to the provisioning, license tiers, and/or permissions of its users, additional characteristic data about the users, such as their usage data and HR data, are correlated to the changes, and the machine learning model is trained to identify or predict what changes, if any, will be made to a given user based on their characteristic data.

In some implementations, the learning module 504, which can include a machine learning model, is configured to learn settings for the dynamic exempt lists based on the corresponding static exempt lists. Characteristics of users placed on the global/app-specific static exempt list can be analyzed/learned, and commonly occurring characteristics can be used to define suggested or default settings for the corresponding global/app-specific dynamic exempt list. It will be appreciated that the characteristics of users can include app usage data and HR data of the users, so that the learning module 504 learns to identify or predict what users would be likely candidates for the static exempt lists based on their app usage characteristics and HR characteristics, and these features can be used as suggestions or defaults for the dynamic exempt lists.

It will be appreciated that implementations of the disclosure for elastic license management provide many advantages to customers of an SMP. In today's environment, IT managers are under pressure to efficiently provide licenses and control cost, and this naturally includes taking away licenses that aren't needed. However, they want to make sure they aren't accidentally disrupting someone's workday, or preventing them from being productive, by taking away a license when they really should be maintaining the license. Hence, implementations of the present disclosure provide a technical solution to the problem of efficient software license management by not stopping employee access when it should be allowed to continue. IT managers may be hesitant to revoke licenses for fear of receiving complaints as a result. But with elastic license management systems of the present disclosure, license management can be intelligently automated so that such actions are based on app usage and other considerations so as to avoid incorrectly revoking licenses.

By keeping the number of licenses to a customer's current need, this helps address issues of cost, resource consumption, security, and compliance. By not paying for unused licenses, cost is reduced, and cloud and network resource usage can be reduced by not unnecessarily instantiating application sessions or managing related data. Extraneous licenses for users that don't use software can pose a security issue, as they are not likely to take steps to maintain security such as changing the password periodically. And if licenses are not managed properly, a user might have a license after they have left the company, in which case the company will be out of compliance with their licensing obligations.

In addition to right-sizing the number of licenses, by automatically adjusting the license tiers and permission levels of users, the benefits of elastic license management are extended even further. Again, downgrading users to an appropriate license tier provides benefits in terms of cost and efficiency, as cloud compute and networking resources are not wasted on unused features. And by automatically upgrading license tiers for those that need it, user productivity is enhanced by providing the tools which suit the needs of users proactively, and without incurring additional friction of processes such as requiring users to submit requests/tickets for license upgrades. By rightsizing permissions of users, the principle of minimum privilege can be more thoroughly implemented, so that users have the minimum privileges and permissions necessary to perform their job functions. This is a desirable security practice that is generally very difficult to properly implement and maintain. However, the present implementations of elastic license management enable automation of permission settings that enhance security.

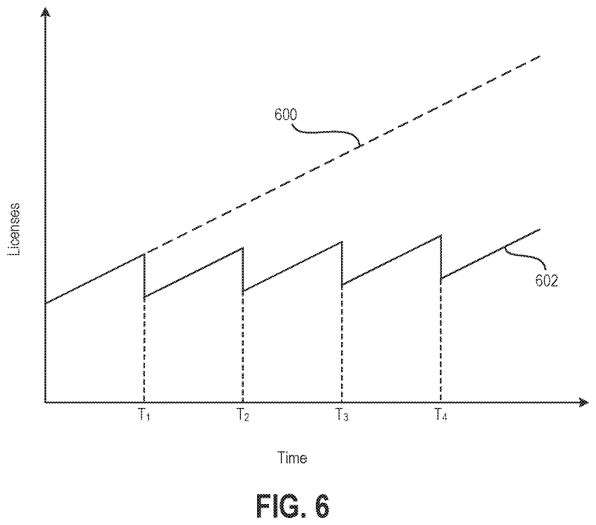

FIG. 6 illustrates a graph conceptually showing the benefits of elastic license management in terms of the number of licenses provisioned for a given app, in accordance with implementations of the disclosure.

In the illustrated graph, the number of licenses versus time is shown for a given customer, for one or more apps of which the customer is a subscriber or licensee. The curve 600 represents the number of licenses typically seen over time absent implementation of elastic license management as described herein. As shown, the number of licenses generally increases over time at a rapid rate, as new users are continually provisioned for one or more of the apps.

However, in contrast to the curve 600, the curve 602 represents the number of licenses over time with an implementation of elastic license management in accordance with implementations of the disclosure. As shown by curve 602, elastic license management operations are performed periodically at times T1, T2, T3, T4, etc., and in each instance, the number of licenses is reduced upon the performance of such operations, following which the number of licenses resumes growing. In this manner, the overall number of licenses may continue to grow, but at a significantly reduced rate as compared to that shown by curve 600. For periodic implementation of elastic license management operations enables regular license reclamation through deprovisioning of users that do not need their licenses.

In one configuration, the SMP includes compute and storage resources for management of SaaS applications. As described above, a web user interface (UI) can be provided to enable remote client devices to use and access services of the SMP. In some implementations, at least some code integrated with the UI is configured to make API calls to the SMP to access data, compute and storage resources. In one embodiment, the compute and storage resources which run the SMP are run in a cloud-based environment. The cloud-based environment, for example, may be provided by a cloud compute and storage servicing entity, e.g., such as Amazon Web Services (AWS)™, Google™ Cloud, Microsoft™ Azure™, or other serving entities. In some configurations, hybrid cloud systems may be used, wherein some processes are executed by a cloud compute and storage servicing entity and other processes are serviced by private servers and storage or a private cloud. In still other embodiments, the processing can be executed entirely on private services and storage or private cloud configuration. In some embodiments, the servicing entities are referred to as hosting services, which provide the hardware and internet connectivity to execute applications, processes, and workflows using various types of hardware configurations.

In some configurations, data that is retrieved from the various SaaS entities using APIs or other accessing code can be stored in one or more databases that make access and further processing more efficient. By way of example, a relational database may be executed for storing data, retrieval of data, and manipulation (e.g., processing) of data. In one embodiment, the database may use a structured query language (SQL) as the programming language that is used to manage relational database data and perform various operations on the data in them. Without limitation, sometimes databases may be referred to as relational database management systems (RDBMS), relational data stream management systems (RDSMS), or simply a database. Generally, relational databases are particularly useful in handling structured data, i.e., data incorporating relations among entities and variables, such as data obtained and processed by an SMP. It should be understood that other database standards or protocols can be used, so long as the processing of SaaS data can be performed for rendering benchmarking and analytics and/or presentation tasks.

In some configurations, the hardware configurations may include virtualized hardware and expandable storage to meet the processing needs of the SMP. Broadly speaking, the SMP is executed using cloud infrastructure, which includes the use of one or more multiple interconnected data centers throughout the world. Based on the load demands for servicing the SMP, the resources may be expanded.

It should be apparent that the present embodiments may be practiced without some or all of these specific details. Modification to the modules, code and communication interfaces are also possible, so long as the defined functionality for the SMP or modules of the SMP is maintained. In other instances, well-known process operations have not been described in detail in order not to unnecessarily obscure the present embodiments.

One or more embodiments can also be fabricated as computer-readable code on a non-transitory computer-readable storage medium. The non-transitory computer-readable storage medium is any non-transitory data storage device that can store data, which can thereafter be read by a computer system. Examples of the non-transitory computer-readable storage medium include solid state drives (SSDs), hard drives, network attached storage (NAS), read-only memory, random-access memory, persistent memory, CD-ROMs, CD-Rs, CD-RWs, magnetic tapes and other optical and non-optical data storage devices. The non-transitory computer-readable storage medium can include computer-readable storage medium distributed over a network-coupled computer system so that the computer-readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

While the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the described embodiments and sample appended claims.

1. A method implemented in a Software as a Service (SaaS) management platform (SMP), the SMP implemented in a cloud resource having at least one processor and at least one storage device, the method comprising:
training a machine learning model on logged changes to user license tiers of a SaaS application by a customer of the SMP, and applying the machine learning model to dynamically determine a setting of an exempt list, wherein the setting identifies one or more categories or types of users that are exempt from changes to provisioning status for the SaaS application, and wherein the training and applying of the machine learning model is repeated over time as logged changes to user license tiers are updated;
obtaining, over a network, usage data from the SaaS application, the usage data identifying interactivity with the SaaS application by users associated with the customer of the SMP;
analyzing the usage data to determine a target provisioning status for selected ones of the users;
accessing the exempt list to determine whether any of the selected ones of the users are exempt from changes to provisioning status;
for the selected ones of the users that are not determined to be exempt, then performing an operation to change a current provisioning status to the target provisioning status, wherein changing the current provisioning status to the target provisioning status is defined by downgrading at least some of the selected ones of the users that are not exempt from a current license tier of the SaaS application to a lower license tier of the SaaS application;
wherein the operation of changing the current provisioning status to the target provisioning status includes accessing, over the network, an application programming interface (API) of a single sign-on (SSO) provider to initiate the downgrading from the current license tier to the lower license tier.

2. The method of claim 1, wherein determining whether any of the selected ones of the users are exempt from changes to provisioning status includes determining whether any of the selected ones of the users are members of the categories or types of users identified by the exempt list.

3. The method of claim 1, wherein the exempt list identifies one or more specific users that are exempt from changes in provisioning status.

4. The method of claim 1, wherein the exempt list identifies a minimum time period after initial provisioning during which users are exempt from changes in provisioning status.

5. The method of claim 1, further comprising:
obtaining, over the network, human resources (HR) data about the selected ones of the users; and,
wherein determining whether any of the selected ones of the users are exempt includes analyzing the HR data based on the exempt list to determine whether any of the selected ones of the users are exempt from changes to provisioning status.

6. The method of claim 5, wherein the exempt list identifies one or more roles, job titles, or departments that are exempt from changes in provisioning status.

7. The method of claim 5, wherein the exempt list identifies a leave of absence, paid time off, sabbatical, vacation or leave status that is exempt from changes in provisioning status.

8. The method of claim 1, wherein analyzing the usage data includes identifying the selected ones of the users as exhibiting interactivity with the SaaS application that falls below a predefined threshold.

9. The method of claim 8, wherein the interactivity with the SaaS application that falls below a predefined threshold is defined by a lack of login or usage activity occurring within a preceding time period.

10. The method of claim 8, wherein the target provisioning status is defined by deprovisioning of the selected ones of the users from the SaaS application.

11. (canceled)

12. (canceled)

13. A non-transitory computer-readable medium having program instructions embodied thereon that, when executed by a cloud resource having at least one processor and at least one storage device, cause said cloud resource to perform a method implemented in a Software as a Service (SaaS) management platform (SMP), the method including the following operations:
training a machine learning model on logged changes to user license tiers of a SaaS application by a customer of the SMP, and applying the machine learning model to dynamically determine a setting of an exempt list, wherein the setting identifies one or more categories or types of users that are exempt from changes to provisioning status for the SaaS application, and wherein the training and applying of the machine learning model is repeated over time as logged changes to user license tiers are updated;
obtaining, over a network, usage data from the SaaS application, the usage data identifying interactivity with the SaaS application by users associated with the customer of the SMP;
analyzing the usage data to determine a target provisioning status for selected ones of the users;
accessing the exempt list to determine whether any of the selected ones of the users are exempt from changes to provisioning status;
for the selected ones of the users that are not determined to be exempt, then performing an operation to change a current provisioning status to the target provisioning status, wherein changing the current provisioning status to the target provisioning status is defined by downgrading at least some of the selected ones of the users that are not exempt from a current license tier of the SaaS application to a lower license tier of the SaaS application;
wherein the operation of changing the current provisioning status to the target provisioning status includes accessing, over the network, an application programming interface (API) of a single sign-on (SSO) provider to initiate the downgrading from the current license tier to the lower license tier.

14. The non-transitory computer-readable medium of claim 13, wherein determining whether any of the selected ones of the users are exempt from changes to provisioning status includes determining whether any of the selected ones of the users are members of the categories or types of users identified by the exempt list.

15. The non-transitory computer-readable medium of claim 13, wherein the exempt list identifies a minimum time period after initial provisioning during which users are exempt from changes in provisioning status.

16. The non-transitory computer-readable medium of claim 13, further comprising:
obtaining, over the network, human resources (HR) data about the selected ones of the users; and,
wherein determining whether any of the selected ones of the users are exempt includes analyzing the HR data based on the exempt list to determine whether any of the selected ones of the users are exempt from changes to provisioning status.

17. The non-transitory computer-readable medium of claim 16, wherein the exempt list identifies one or more roles, job titles, or departments that are exempt from changes in provisioning status.

18. The non-transitory computer-readable medium of claim 13, wherein analyzing the usage data includes identifying the selected ones of the users as exhibiting interactivity with the SaaS application that falls below a predefined threshold.

19. The non-transitory computer-readable medium of claim 18, wherein the target provisioning status is defined by deprovisioning of the selected ones of the users from the SaaS application.

20. (canceled)

21. (canceled)

22. (canceled)
